(19) United States
(12) Patent Application Publication
(10) Pub. No.: US 2015/0133165 A1
(43) Pub. Date: May 14, 2015

(54) METHOD FOR PROCESSING DATA AND ELECTRONIC DEVICE THEREOF

(71) Applicant: Samsung Electronics Co., Ltd., Suwon-si (KR)

(72) Inventor: Eun-Jun PARK, Suwon-si (KR)

(21) Appl. No.: 14/463,224

(22) Filed: Aug. 19, 2014

(30) Foreign Application Priority Data
Nov. 11, 2013 (KR) 10-2013-0136341

(51) Int. Cl. H04W 4/02; H04L 29/08

(52) U.S. Cl. CPC H04W 4/02; H04L 67/18
USPC 455/456.3

(57) ABSTRACT

An operation method of an electronic device is provided. The method includes detecting status information and location information of the electronic device requesting for a list of at least one related content based on the detected status information and the detected location information, to another electronic device, receiving the list of at least one related content from the other electronic device; and displaying the received list of at least one related content.

### CROSS-REFERENCE TO RELATED APPLICATION(S)

This application claims the benefit under 35 U.S.C. §119(a) of a Korean patent application filed on Nov. 11, 2013 in the Korean Intellectual Property Office and assigned Serial number 10-2013-0136341, the entire disclosure of which is hereby incorporated by reference.

### TECHNICAL FIELD

The present disclosure relates to a method for processing data and an electronic device thereof.

### BACKGROUND

With the growth of mobile communication technologies, electronic devices are used as essential personal communication devices. Further, as the electronic devices provide not only a voice communication function but also various supplementary services such as photography, data communication, video reproduction, audio reproduction, messengering, schedule management, alarm functions and the like, various programs capable of using the aforementioned functions are used, and the number of programs installed in the electronic devices are greatly increasing as well.

To get recommendations for contents information through network communication in an electronic device, the electronic device selects a list of contents on a designated area or period and receives the contents information. Or, the electronic device may acquire a location of the electronic device and select at least one of content provided for the location of the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device may acquire a list of contents which are consumed in an area and environment (e.g., status information) in which the electronic device is located.

Another aspect of the present disclosure is to provide an electronic device may acquire a list of contents which are consumed in the same or similar environment in accordance to movement information of the electronic device.

In accordance with an aspect of the present disclosure, a method of an electronic device is provided. The method includes detecting status information and location information of the electronic device requesting for a list of at least one or more related contents based on the detected status information and the detected the location information, to another electronic device, receiving the list of at least one or more related contents from the other electronic device, and displaying the received list of at least one or more related contents.

In accordance with another aspect of the present disclosure, an operation method of an electronic device is provided. The method includes receiving status information including location information of another electronic device, from the other electronic device, determining a list of at least one related content in accordance to an area attribute corresponding to a location of the other electronic device based on the location information of the other electronic device, and providing the determined list to the other electronic device.

In accordance with another aspect of the present disclosure, an electronic device is provided. The electronic device includes a display, a communication interface configured to communicate with another electronic device, and at least one processor operatively coupled to the display and the communication interface, the at least one processor configured to perform detecting status information and location information of the electronic device, requesting for a list of at least one related content based on the detected status information and the detected the location information to other electronic device, receiving the list of at least one related content from the other electronic device, and displaying the received list of at least one related content.

In accordance with another aspect of the present disclosure, an electronic device is provided. The electronic device includes a communication interface configured to communicate one of information and a list of contents with another electronic device, and at least one processor programed to receive status information and location information of other electronic device from the other electronic device, to detect a list of at least one related content based on the received status information and the received location information, and to provide the detected list of at least one related content to the other electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other objects, features and advantages of certain embodiments of the present disclosure will become more apparent from the following description taken in conjunction with the accompanying drawings, in which:

FIG. 1 is a block diagram illustrating a construction of an electronic device 101 according to various embodiments of the present disclosure;

FIG. 2 is a diagram illustrating an operation of transmitting/receiving data with a server or other electronic device in an electronic device according to various embodiments of the present disclosure;

FIG. 3 is a block diagram illustrating a construction of a data processing module 105 in an electronic device according to various embodiments of the present disclosure;

FIGS. 4A and 4B are diagrams illustrating an operation of transmitting/receiving data in an electronic device or a server according to various embodiments of the present disclosure;

FIGS. 5A, 5B, 5C, and 5D are diagrams illustrating an operation of transmitting/receiving data in an electronic device or a server according to various embodiments of the present disclosure;

FIG. 6 is a flowchart illustrating an operation of transmitting/receiving data in an electronic device or a server according to various embodiments of the present disclosure;

FIG. 7 is a flowchart illustrating an operation of transmitting/receiving data in an electronic device or a server according to various embodiments of the present disclosure; and

FIG. 8 is a block diagram illustrating a construction of hardware according to embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to at least one of such surface.

An electronic device according to various embodiments of the present disclosure may be a device including a communication function. For example, the electronic device may include at least one of a smart phone, a tablet Personal Computer (PC), a mobile phone, a video phone, an electronic book reader, a desktop PC, a laptop PC, a netbook computer, a Personal Digital Assistant (PDA), a Portable Media Player (PMP), an MPEG Audio Layer 3 (MP3) player, a mobile medical instrument, a camera, and a wearable device (e.g., a Head Mounted Display (HMD) such as electronic glasses, electronic clothes, an electronic bracelet, an electronic necklace, an electronic accessory, or a smart watch).

According to some embodiments, the electronic device may be smart electronic home appliances having a communication function. The smart electronic home appliances may include, for example, at least one of a television, a Digital Versatile Disc (DVD) player, an audio system, a refrigerator, an air conditioner, a cleaner, an oven, a microwave, a washing machine, an air cleaner, a settop box, a TV box (for example, Samsung HomeSyn™, AppleTV™, or Google TV™), a game console, an electronic dictionary, an electronic locking system, a camcorder, and an electronic frame.

According to various embodiments, the electronic device may include at least one of various medical instruments (e.g., Magnetic Resonance Angiography (MRA), Magnetic Resonance Imaging (MRI), Computerized Tomography (CT), a moving-camera, an ultrasound machine and the like), a navigation device, a Global Positioning System (GPS) receiver, an Event Data Recorder (EDR), a Flight Data Recorder (FDR), a vehicle infotainment device, a vessel electronic equipment (e.g., a vessel navigation device, a gyrocompass and the like), a flight electronic instrument, and a security instrument.

According to some embodiments, the electronic device may include at least one of part of a furniture or building/structure having a communication function, an electronic board, an electronic signature input device, a projector, and various metering instruments (e.g., tap water, electricity, gas or radio wave and the like). The electronic device according to various embodiments of the present disclosure may be one of the aforementioned various devices or a combination of at least two. Also, it is obvious to those skilled in the art that the electronic device according to various embodiments of the present disclosure is not limited to the aforementioned instruments. The electronic devices according to the embodiments of the present disclosure will be described below with reference to the accompanying drawings. The term of ‘user’ used in the various embodiments of the present disclosure may denote a person who uses an electronic device or a device (e.g., an artificial intelligent electronic device) which uses the electronic device.

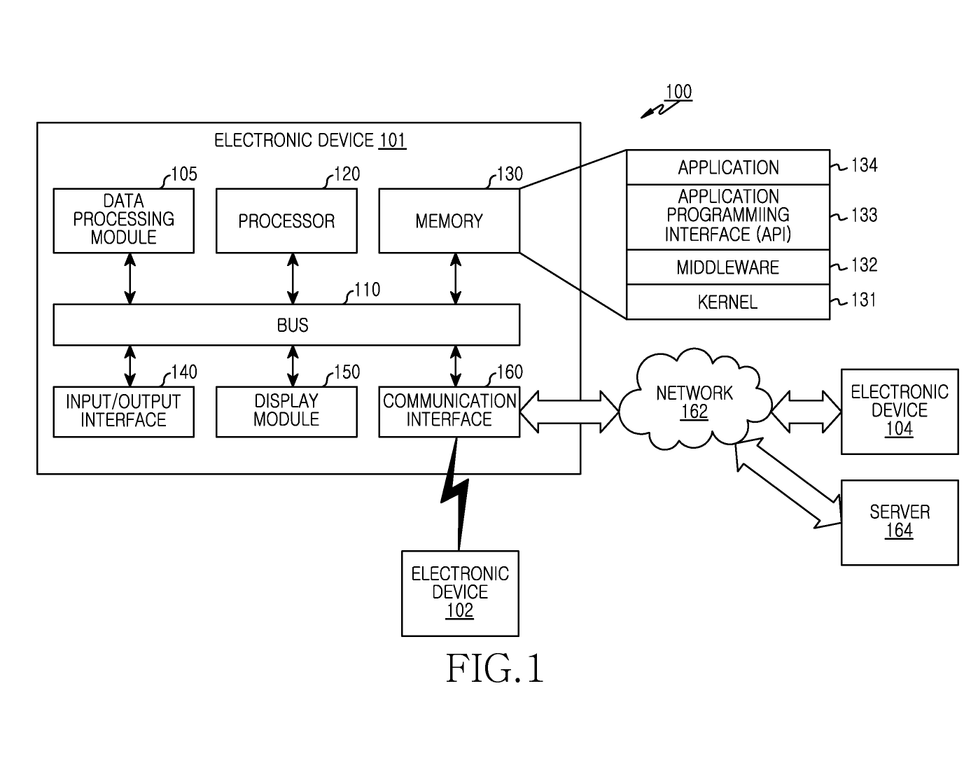

FIG. 1 is a block diagram illustrating a construction of an electronic device according to various embodiments of the present disclosure.

Referring to FIG. 1, a system 100 having an electronic device 101 may include a data processing module 105, a bus 110, a processor 120, a memory 130, an input/output interface 140, a display module 150, and a communication interface 160, but is not limited thereto.

The data processing module 105 may acquire location information of the electronic device 101, movement status information of the electronic device 101, and external status information of the electronic device 101 through at least one sensor (not shown) included in the electronic device 101. The data processing module 105 may control to transmit the acquired at least one information to the server 164. In transmitting the acquired at least one information to the server 164, the data processing module 105 may transmit together information requesting a recommendation list (i.e., a recommendation contents list or a related contents list) of contents desired by a user, to the server 164.

The data processing module 105 may provide at least one content to the electronic device 101, with reference to a recommendation contents list received from the server 164. In providing the contents to the electronic device 101, the data processing module 105 may filter the acquired recommendation contents list on at least one designated condition, and may provide the filtering result and contents corresponding to the filtering result to the electronic device 101.

The data processing module 105 may generate a list of contents corresponding to at least one item, with reference to location information of one or other electronic devices received from the one or other electronic devices, movement status information of the other electronic devices, external status information of the other electronic devices, and log information about contents consumption according to locations and statuses of the other electronic devices. The electronic device 101 may determine a recommendation contents list with reference to the contents list which is generated in accordance to recommendation contents list request information received from the other electronic devices, the location information of the other electronic devices, and the status information of the other electronic devices, and may transmit the determined recommendation contents list to the other electronic devices having requested the recommendation contents list.

The bus 110 may be a circuit connecting the aforementioned constituent elements with one another and forwarding communication (e.g., a control message) between the aforementioned constituent elements.

The processor 120 may receive instructions from the aforementioned other constituent elements (e.g., the memory 130, the input/output interface 140, the display module 150, the communication interface 160, and the like) through the bus 110, decipher the received instructions, and execute operation or data processing according to the deciphered instructions, for example.

The memory 130 may store an instruction or data which is received from the processor 120 or the other constituent elements (e.g., the input/output interface 140, the display module 150, the communication interface 160, and the like) or is generated by the processor 120 or the other constituent elements. The memory 130 may include, for example, programming modules such as a kernel 131, a middleware 132, an Application Programming Interface (API) 133, applications 134 and the like. The aforementioned programming modules each may be composed of software, firmware, hardware or a combination of at least two of them.

The kernel 131 may control or manage system resources (e.g., the bus 110, the processor 120, the memory 130 and the like) used for executing operations or functions implemented by the remnant other programming modules (e.g., the middleware 132, the API 133, and the application 134). The kernel 131 may provide an interface of enabling the middleware 132, the API 133, or the applications 134 to access and control or manage the individual constituent element of the electronic device 101.

The middleware 132 may perform a relay role of enabling the API 133 and/or the application 134 to communicate and exchange data with the kernel 131. Also, in relation to work requests received from the applications 134, the middleware 132 may perform, for example, work request load balancing using a method of allocating at least one of the applications 134 the order of priority capable of using the system resources (e.g., the bus 110, the processor 120, the memory 130 or the like) of the electronic device 101.

The API 133 is an interface for enabling the application 134 to control a function provided by the kernel 131 or the middleware 132. The API 133 may include, for example, at least one interface or function for file control, window control, picture processing, character control and the like.

The input/output interface 140 may receive an input of an instruction and/or data from a user and forward the instruction or data to the processor 120 and/or the memory 130 through the bus 110, for example. The display module 150 may display a picture, a video, data and the like to the user. According to one exemplary embodiment, if the display module 150 is provided as a touch screen panel, the display module 150 may input an instruction through a gesture of touching or hovering (e.g., indirect touch input) the display module 150.

The communication interface 160 may establish communication between the electronic device 101 and the electronic device 102 or an electronic device 104 or the server 164. The communication interface 160 may support a certain short-range communication protocol (e.g., Wireless Fidelity (WiFi), Bluetooth (BT), or Near Field Communication (NFC)) and a certain network communication 162 (e.g., the Internet, a Local Area Network (LAN), a Wide Area Network (WAN), a telecommunication network, a cellular network, a satellite network, a Plain Old Telephone System (POTS) or the like). The electronic devices 102 and 104 each may be the same (e.g., same type) as the electronic device 101 or may be a different (e.g., different type) device.

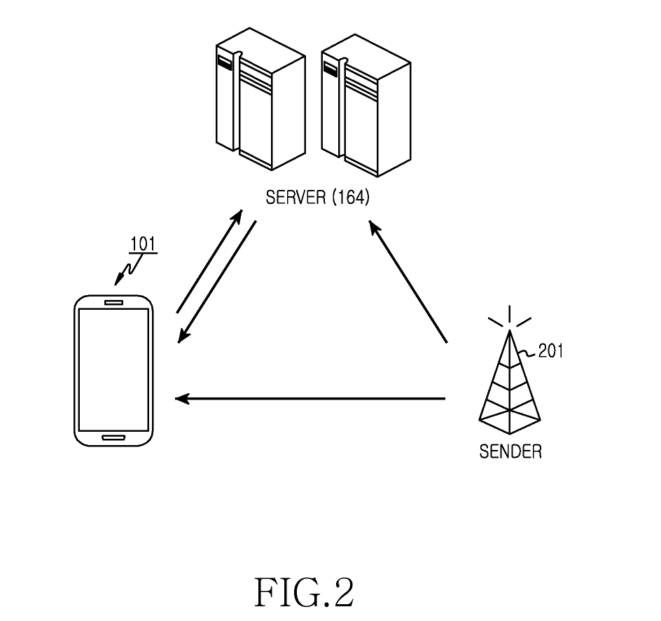

FIG. 2 illustrates an operation of transmitting/receiving data with a server or other electronic device in an electronic device according to an embodiment of the present disclosure.

Referring to FIG. 2, the electronic device 101 may receive requested data from the other electronic device (e.g., sender) 201 or the server 164, and may transmit at least one datum updated with reference to the received data, to the server 164. According to one exemplary embodiment, when the electronic device 101 intends to download a recommendation music list corresponding to location information in which the electronic device 101 is located, the electronic device 101 may acquire the location information of the electronic device 101, and transmit the acquired location information and a recommendation music list transmission request to the server 164 connected by network communication. According to one exemplary embodiment of acquiring the location information of the electronic device 101, the electronic device 101 may determine the location information through at least one of base station triangulation, a GPS, a gyroscope sensor, a geomagnetic sensor, an accelerometer sensor, a WiFi sensor (e.g., a WiFi fingerprint technique), WiFi triangulation, and a Zigbee sensor. If the recommendation music list corresponding to the location information exists in the server 164, the server 164 may transmit the recommendation music list corresponding to the location information of the electronic device 101, to the electronic device 101. The electronic device 101 may directly receive the requested recommendation music list from the server 164. Or, in accordance with the control of the server 164, the server 164 may receive the requested recommendation music list from the other electronic device 201 which includes the recommendation music list corresponding to the location information of the electronic device 101 and is located in a range capable of transmitting data to the electronic device 101. After the electronic device 101 plays at least one song among the received recommendation music list corresponding to the location information of the electronic device 101, the electronic device 101 may transmit changed log data of the recommendation music list to the server 164. According to one exemplary embodiment of the log data transmitted by the electronic device 101 to the server 164, the log data may include at least one of a use pattern of the electronic device 101, a use record of the electronic device 101, a user profile of the electronic device 101, contents search information of a user, a data use amount, a received contents preference, contents information being in use, and an external status (e.g., a temperature, an altitude, a noise, a weather and the like) of the electronic device 101. The electronic device 101 may acquire the log data in accordance to a designated period, and may transmit the acquired log data to the server 164.

With reference to data received from the other electronic device 201, the server 164 may update a database included in the server 164, and may transmit all or part of data of the updated database of the server 164 to the electronic device 101 in response to a request of the electronic device 101. The database of the server 164 may acquire information about an attribute of contents which are consumed in an area designated based on map data, and may generate an area attribute table with reference to the acquired information about the contents and at least one designated area of the map data.

The server 164 may receive data from the electronic device 101 and update the database of the server 164 with the received data. According to one exemplary embodiment, the server 164 may include at least one map data in the database, and may determine at least one designated area among the map data. In determining the designated area, the designated area may include at least one of a polyline area expressing a 2-Dimensional (2D) area through a line, a polygon area expressing a 2D or 3-Dimensional (3D) area, and a pointer location expressing a location area. According to one exemplary embodiment, a method of determining a designated area of the electronic device 101 may include all or part of a Point of Interest (POI) system including not only a point, but also various space information, such as a 2D line string area, a 2D polygon area, and a 3D stereo space area. The server 164 may provide a function for setting a user-defined space area of map data by a user, and may provide to generate a recommendation contents list applied for the user. Further, the database of the server 164 may generate differentiated context information based on at least one of a use pattern of the electronic device 101, a use record of the electronic device 101, a user profile, external status information (e.g., a weather, a temperature, an altitude and the like) of the electronic device 101, a contents (e.g., video) rental system, and a media data (e.g., sound source per country) ranking system through location information received from the electronic device 101 and status information of the electronic device 101. Through the differentiated context information, the database of the server 164 may provide recommendation contents adapted to the electronic device 101 of an individual user.

The sender 201 may send the electronic device 101 the recommendation contents list that the electronic device 101 having requested to the server 164. The sender 201 may be at least one other electronic device including data requested by the electronic device 101 that the server 164 controls to transmit the data to the electronic device 101. The sender 201 is a device connecting with the electronic device 101 through network communication and capable of transmitting/receiving the data. Referring to FIG. 1, the sender 201 may be at least one of the electronic device 102, the electronic device 104, and the server 164.

According to various embodiments, the electronic device 101, the server 164, and the sender 201 are distinguished and described in FIG. 2. This is merely for clear understanding of the present disclosure, and the electronic device 101 may function including all or part of the server 164 and all or part of the sender 201.

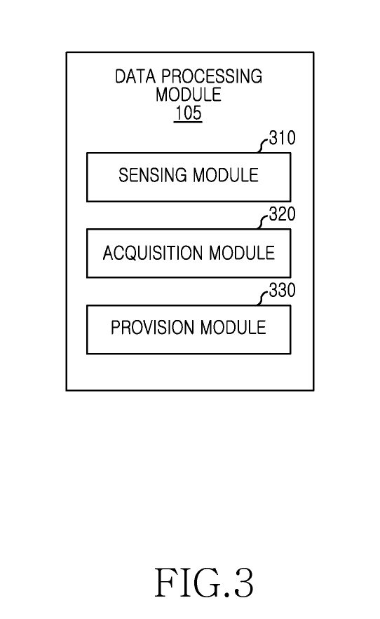

FIG. 3 is a block diagram illustrating a construction of a data processing module 105 in the electronic device 101 according to various embodiments of the present disclosure.

Referring to FIG. 3, the data processing module 105 may include at least one module among a sensing module 310, an acquisition module 320, and a provision module 330.

Various embodiments of each module are described below.

The sensing module 310 may acquire location information of the electronic device 101 and status information of the electronic device 101. The sensing module 310 may acquire the status information of the electronic device 101 through at least one sensor included in the electronic device 101. According to one exemplary embodiment, the sensing module 310 may acquire the location information of the electronic device 101 through at least one of a GPS, a gyroscope sensor, a geomagnetic sensor, an accelerometer sensor, a WiFi sensor, a communication module, and a Zigbee sensor. The sensing module 310 may control to acquire the status information of the electronic device 101 through at least one of a temperature sensor, a grip sensor, an altitude sensor, and a pressure (air pressure) sensor.

The acquisition module 320 may control to acquire information about at least one content from the server 164. According to one exemplary embodiment, the acquisition module 320 may transmit the acquired location information of the electronic device 101 and/or at least one status information of the electronic device 101 to the server 164. And, the acquisition module 320 may transmit to the server 164 a request for a recommendation contents list corresponding to the location information of the electronic device 101 and/or the at least one status information of the electronic device 101. The acquisition module 320 may receive requested data from the server 164 or from the other electronic device 104 that controls the server 164 to transmit information about at least one content to the electronic device 101.

The provision module 330 may control the electronic device 101 to provide information about received contents. According to one exemplary embodiment, the provision module 330 may provide the information about the received contents (e.g., a recommendation music list) to the display module 150 of the electronic device 101. When providing the information about the received contents to the electronic device 101, the provision module 330 may filter the received contents with reference to setting information included in the electronic device 101, and may provide at least one of the content information acquired through the filtering. The provision module 330 may record used log information among the information about the at least one content provided to the electronic device 101, and may transmit the log information to the server 164 for the sake of for updating of the database of the server 164.

The operating of the data processing module 105 may be performed by controlling of the process 120 or the predetermined module (e.g., controller, MCU). And the processor may perform the operating of the data processing module 105

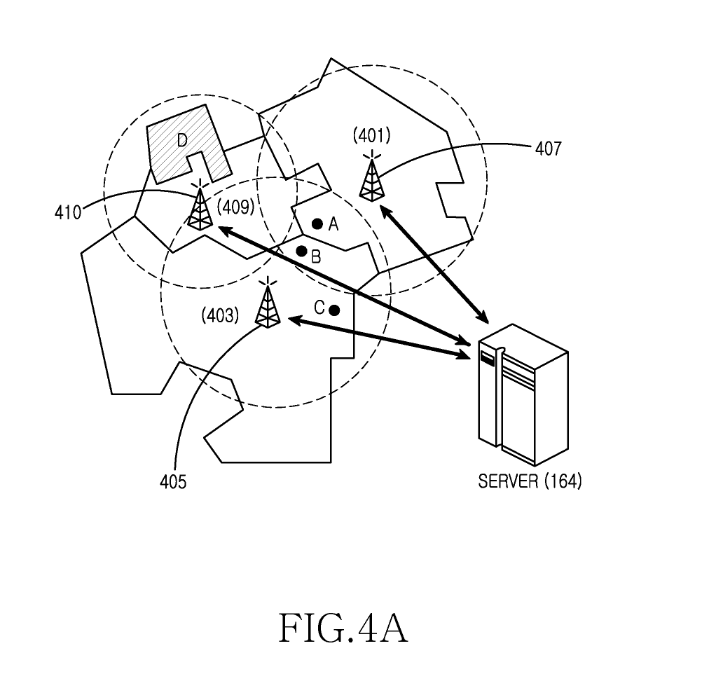

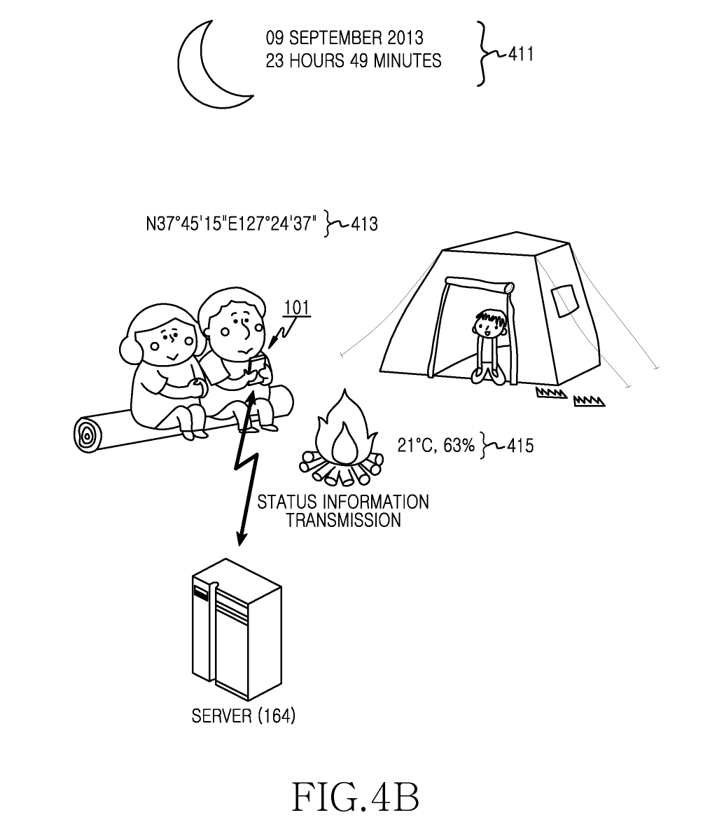

FIGS. 4A and 4B illustrate an operation of transmitting/receiving data in an electronic device or a server according to various embodiments of the present disclosure.

The electronic device 101 may transmit to the server 164 a request for a recommendation contents list corresponding to location information of the electronic device 101. The server 164 may determine a category corresponding to the location information of the electronic device 101 among contents of the database of the server 164 or information about the contents with reference to the location information of the electronic device 101 included in recommendation contents list request information of the electronic device 101. The server 164 may determine a recommendation contents list with reference to status information of the electronic device 101 included in the recommendation contents list request information of the electronic device 101.

According to an embodiment, in managing the contents of the database or a list of the contents, the server 164 may divide an area of a map (e.g., a map program) included in the database into at least two areas, and may acquire information about at least one content consumed in each area. In dividing the area of the map, the server 164 may subdivide the area of the map into at least one sub area (e.g., sub areas such as states, counties, cities, and avenues). The server 164 may acquire the information about the contents consumed in the divided at least one area of the map, through the electronic device 101 or other electronic devices connected with the server 164 through network communication. According to one embodiment, in a case where the electronic device 101 or the other electronic devices connected with the server 164 through the network communication receive the contents of the database through the network communication or consume recommended contents, the electronic device 101 or the other electronic devices connected with the server 164 through the network communication may acquire or record information about at least one item (e.g., status information of a time point of consumption of contents) such as the consumed contents, a surrounding environment of the electronic device 101 of the time point of consumption of the contents (e.g., a user's gender set to the electronic device 101), the kind of the contents, a genre of designated media data, an external temperature of the electronic device 101 (e.g., a temperature acquired by the electronic device 101), and a contents consumption time. The electronic device 101 may transmit log data about the aforementioned items (e.g., area attribute) to the server 164. With reference to the log data acquired from the electronic device 101 or the other electronic devices, the server 164 may determine and distinguish a list of consumed contents in accordance to a designated range among the aforementioned items corresponding to the divided areas. By inputting the information about the at least one item in the database, the server 164 may acquire a recommendation contents list of a corresponding condition. The server 164 is not limited to the aforementioned database configuration method. By the well-known data clustering technique, the server 164 may divide data based on location information or an area attribute of a designated location.

The server 164 may transmit to the electronic device 101 the recommendation contents list which is determined with reference to the location information or status information of the electronic device 101 included in the recommendation contents list request information requested by the electronic device 101.

Various embodiments of the present disclosure are described below with reference to FIG. 4A.

Referring to FIG. 4A, the electronic device 101 may confirm a location of the electronic device 101. In accordance to the location, the electronic device 101 may vary acquired data (e.g., a recommendation contents list). According to an embodiment, the database included in the server 164 may include at least one map data. The map data of the database may include a coordinate (e.g., a latitude and a longitude) of a corresponding location of an area included in a map. If the server 164 receives a contents transmission request from the electronic device 101, the server 164 may determine a location of the electronic device 101 in the map data of the database, and may acquire and transmit contents corresponding to the determined location to the electronic device 101.

According to one embodiment, when the electronic device 101 is located in an ‘A’ area of a 1^{st} zone 401 (e.g., an ‘A’ camping resort located in the 1^{st} zone 401), the electronic device 101 may acquire location information about the location of the electronic device 101 in the ‘A’ area. The electronic device 101 may transmit data requesting a recommendation contents list (e.g., a recommendation music list) of the acquired location information, to the server 164. The server 164 may acquire data including corresponding information from the database of the server 164 with reference to the recommendation music list request data received from the electronic device 101 and the location information of the electronic device 101. The server 164 may determine that the electronic device 101 is located in the ‘A’ camping resort located in the 1^{st} zone 401, with reference to the location information of the electronic device 101. The server may determine the recommendation music list stored as an item of the ‘A’ camping resort with reference to the database, and may transmit the corresponding recommendation music list to the electronic device 101. In providing the recommendation contents list according to the location information of the electronic device 101, the server 164 may distinguish contents included in the database, by various location items such as a country, an area (e.g., a designated city), a zone (e.g., an autonomous region, a national park, etc.), and facilities (e.g., a region of a designated purpose such as a camping resort, a temple, a historical site, an amusement park, etc.). The server 164 may determine the order of priority of consumption of contents according to the distinguished location items.

According to an embodiment of determining a recommendation contents list according to location information of the electronic device 101, the server 164 may provide a recommendation contents list corresponding to a feature (i.e., characteristic) of a location of the electronic device 101. For example, the ‘A’ area of FIG. 4A may be a camping resort located in the 1^{st} zone 401, and a ‘B’ area may be a camping resort located in a 2^{nd} zone 403. The server 164 may receive information about contents consumed by a user who uses the ‘A’ camping resort and/or information contents consumed by a user who uses the ‘B’ camping resort, from the electronic device 101 connected with the server 164. And, the server 164 may synthesize the received information and generate a list (e.g., a recommendation contents list of the ‘A’ camping resort or a recommendation contents list of the ‘B’ camping resort) of the order of priority of consumption of contents which are consumed in each area (e.g., the ‘A’ camping resort or the ‘B’ camping resort). If the electronic device 101 located in the ‘A’ camping resort transmits to the sever 164, via sender 401, a recommendation contents list request, the server 164 may transmit the recommendation contents list of the ‘A’ camping resort to the electronic device 101 in response to the request of the electronic device 101. If the electronic device 101 located in the ‘B’ camping resort transmits to the sever 164, via sender 403, a recommendation contents list request, the server 164 may transmit the recommendation contents list of the ‘B’ camping resort to the electronic device 101 in response to the request of the electronic device 101.

According to various embodiments, the electronic device 101 may receive recommendation contents lists corresponding to at least two areas, from the server 164. According to one exemplary embodiment, the electronic device 101 may transmit to the server 164 a request for a recommendation contents list corresponding to location information of the electronic device 101 in accordance to previously designated setting information. In accordance to a response to the request, the electronic device 101 may receive from the server 164 a recommendation contents list corresponding to location information or area information included in the setting information together with the recommendation contents list corresponding to the location information of the electronic device 101.

According to one embodiment, the electronic device 101 may select at least one area in setting of recommendation contents list reception, and may record the aforementioned setting information in the electronic device 101 and the server 164. The electronic device 101 may be located in a ‘C’ camping resort of the 2^{nd} zone 403 in a state where the electronic device 101 selects an area of the ‘A’ camping resort of the 2nd zone 403 and an area of a ‘D’ amusement park of a 3^{rd} zone 409 and stores the setting information in the electronic device 101 and/or the server 164, via sender 410. The electronic device 101 may transmit recommendation contents list request information about a current location to the server 164. The recommendation contents list request information transmitted to the server 164 may include location information (e.g., a coordinate of a location of the electronic device 101 measured by a GPS) of the electronic device 101 and/or at least one status information about a status of a contents consumption time point. The server 164 may determine a recommendation contents list based on the location information of the electronic device 101 and/or the status information of the contents consumption time point which are included in the recommendation contents list request information received from the electronic device 101. The server 164 may additionally determine a recommendation contents list of the ‘A’ camping resort and a recommendation contents list of the ‘D’ amusement park as well as a recommendation contents list of the ‘C’ camping resort which is determined based on the location information and/or status information of the electronic device 101 with reference to the setting information of the electronic device 101 recorded in the database. In determining the recommendation contents list of the ‘A’ camping resort and the recommendation contents resort of the ‘D’ amusement park, the server 164 may determine the recommendation contents list of the ‘A’ camping resort and the recommendation contents resort of the ‘D’ amusement park with reference to the status information of the electronic device 101 included in the recommendation contents list request information about the ‘C’ camping resort received from the electronic device 101. After that, the server 101 may transmit the recommendation contents list of the ‘C’ camping resort, the recommendation contents list of the ‘A’ camping resort, and the recommendation contents list of the ‘D’ amusement park, to the electronic device 101.

Further, in determining a recommendation contents list, with reference to location information of the electronic device 101 included in recommendation contents list request information of the ‘C’ camping resort received from the electronic device 101, the server 164 may determine the recommendation contents list based on at least one other area related to an area attribute (e.g., information distinguished by a purpose such as a camping resort and an amusement park) of an area including the location information of the electronic device 101.

In displaying the recommendation contents list of the ‘C’ camping resort, the recommendation contents list of the ‘A’ camping resort, and the recommendation contents list of the ‘D’ amusement park received from the server 164, the electronic device 101 may display them in accordance to a method set to the setting information of the electronic device 101. According to one exemplary embodiment, if the setting information of the electronic device 101 is set to display the acquired recommendation contents lists in accordance to the order of priority of a distance, when the electronic device 101 displays at least one recommendation contents list (e.g., the recommendation contents list of the ‘C’ camping resort, the recommendation contents resort of the ‘A’ camping resort, and the recommendation contents list of the ‘D’ amusement park) acquired by the electronic device 101, the electronic device 101 may display them in order of close distance on a basis of a location of the electronic device 101. Also, when displaying the acquired recommendation contents lists, the electronic device 101 may display a result of filtering the acquired recommendation contents lists in accordance to the setting information. According to one exemplary embodiment, the electronic device 101 may determine and store in the setting information at least one condition such as the kind of contents to be displayed in the electronic device 101, a genre of the contents, a gender of a consumer who consumes the contents, a contents reproduction time, and the order of the contents. The electronic device 101 may filter the acquired recommendation contents lists in accordance to the conditions stored in the setting information, and display the filtering result. The electronic device 101 may transmit the filtering condition and log information about a list of contents which are consumed by the electronic device 101, to the server 164. And, with reference to the received log information, the server 164 may update the setting information of the electronic device 101 included in the database. In filtering or displaying the received at least one recommendation contents list corresponding to the location information of the electronic device 101, the electronic device 101 may display acquired data through the well-known data merging technique, without being limited to a method according to the aforementioned various embodiments.

Various embodiments of the present disclosure are described below with reference to FIG. 4B.

Referring to FIG. 4B, the electronic device 101 may confirm status information of the electronic device 101, and may vary acquired data in accordance to the status information. The electronic device 101 may acquire the status information of the electronic device 101 through at least one sensor included in the electronic device 101 and acquiring information about an internal or external status of the electronic device 101. According to one exemplary embodiment, the electronic device 101 may acquire external temperature information 415 of the electronic device 101 through a temperature sensor. And, the electronic device 101 may acquire location information 413 of the electronic device 101 by at least one of a GPS, a gyroscope sensor, a geomagnetic sensor, an accelerometer sensor, a WiFi sensor, a communication module, and a Zigbee sensor. And, the electronic device 101 may determine current time information 411 through the server 164 connected with the electronic device 101 through network communication. The electronic device 101 may acquire at least one status information of the electronic device 101, and acquire recommendation contents list request information, and transmit the status information and the recommendation contents list request information to the server 164. The server 164 may determine a requested recommendation contents list with reference to the status information of the electronic device 101 received from the electronic device 101, and may transmit the determined recommendation contents list to the electronic device 101.

Here, according to one embodiment in which the server 164 determines the recommendation contents list, the server 164 may determine an area where the electronic device 101 is located, in a category distinguished in accordance to a location on a map of a database, and may determine contents (or information about the contents) which are consumed in the determined area. At least one content recorded in the server 164 may be distinguished and stored in accordance to at least one item (e.g., an area attribute) among a designated atmospheric temperature (e.g., an atmospheric temperature corresponding to a temperature acquired from the electronic device 101) range, a designated time range, and a designated location range in a corresponding area. The server 164 may acquire a corresponding contents list in the database with reference to the location information and status information of the electronic device 101 received from the electronic device 101. According to one exemplary embodiment, if the server 164 confirms that the electronic device 101 is located in the ‘B’ camping resort of the 2^{nd} zone 403 in FIG. 4A with reference to the location information of the electronic device 101, the server 164 may acquire recommendation contents lists of the 2^{nd} zone 403 in the contents list of the database, and may acquire (e.g., it may be a result of a filtering operation) a recommendation contents list of the ‘B’ camping resort among the acquired recommendation contents lists of the 2^{nd} zone 403. If the server 164 confirms that an atmospheric temperature is equal to 21° C. and humidity is equal to 63% in a location of the electronic device 101 with reference to the temperature information of the electronic device 101, the server 164 may acquire a recommendation contents list of a range (e.g., a range of 20° C. to 29° C.) including the atmospheric temperature 21° C. in the contents list of the database and/or may acquire a recommendation contents list corresponding to a range (e.g., a range of 60% to 69%) including the humidity 63% in the contents list of the database. If the server 164 confirms that it is a current time (e.g., 23 hours 49 minutes, 9 Sep. 2013) received from the electronic device 101 or acquired from the server 164, the server 164 may acquire a recommendation contents list corresponding to a range (e.g., a range of 21 hours to 24 hours) including the current time (e.g., 23 hours 49 minutes) in the contents list of the database. With reference (e.g., mixing, random selecting, merging or filtering) to the at least one recommendation content lists acquired in the respective ranges, the server 164 may generate at least one recommendation contents list. The server 164 may transmit the generated at least one recommendation contents list to the electronic device 101, in response to a recommendation contents list request of the electronic device 101. The electronic device 101 may provide the recommendation contents lists received from the server 164 as they are, or may filter the received recommendation contents lists in accordance to an item (or a condition) that is set to the electronic device 101. If a recommendation contents list provided to a user is different from the recommendation contents list received from the server 164, the electronic device 101 may record a log about corresponding variation or a log about contents consumed in the electronic device 101, and transmit the log to the server 164. By the received log information, the server 164 may update information of the contents included in the database or information about the item.

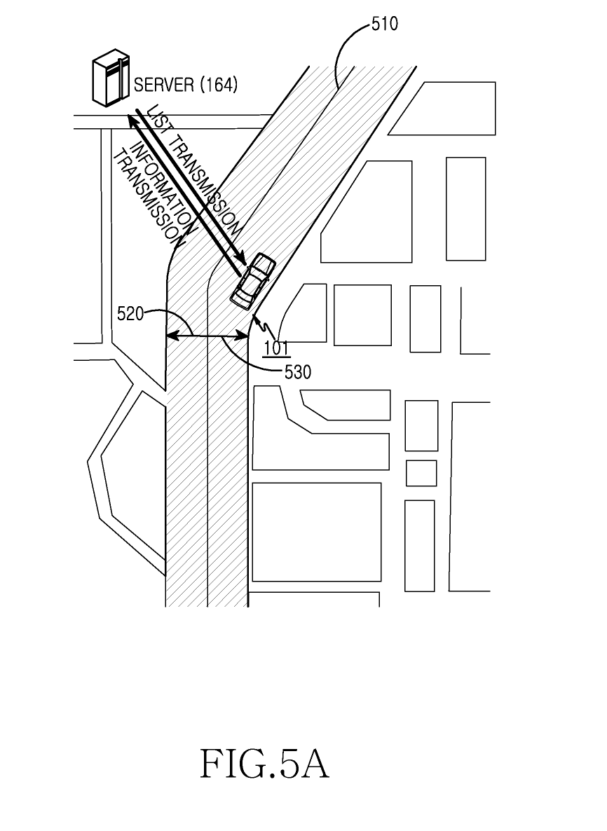

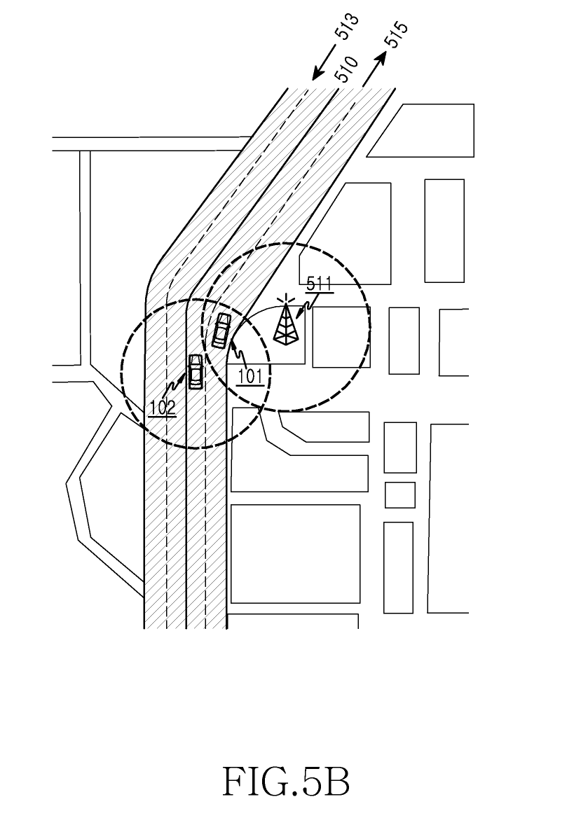

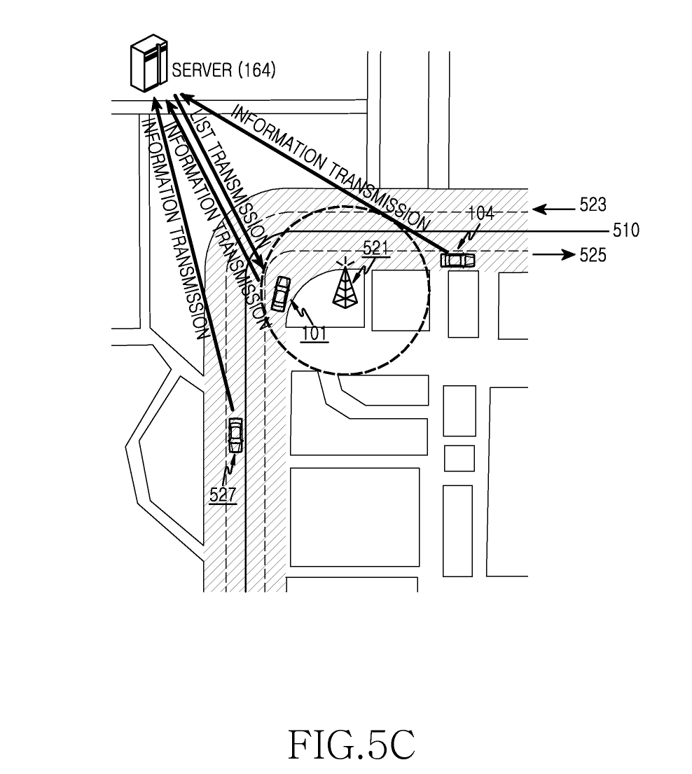

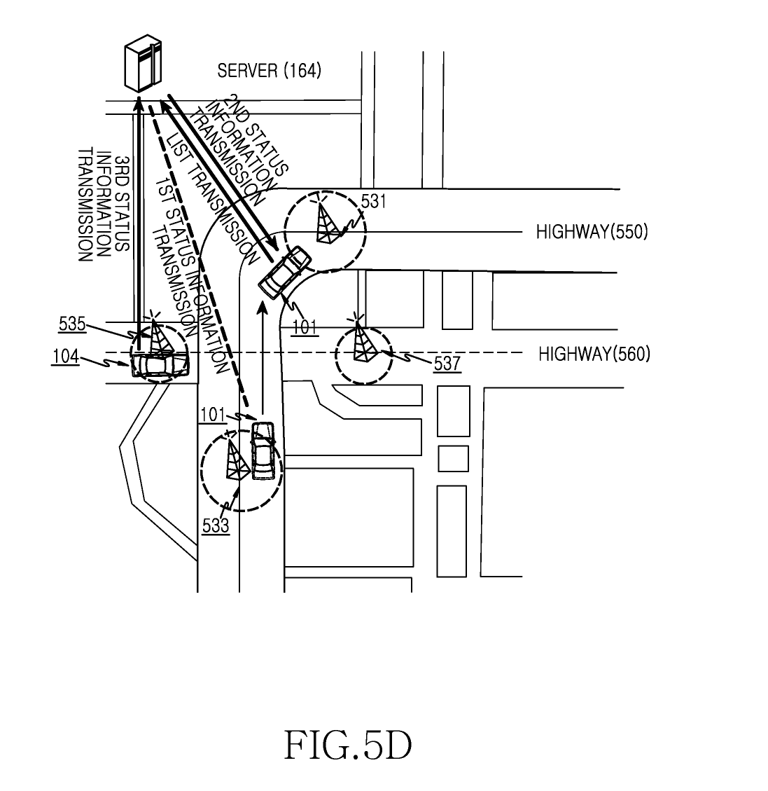

FIGS. 5A to 5D are diagrams illustrating an operation of transmitting/receiving data in the electronic device 101 or the server 164 according to various embodiments of the present disclosure.

Various embodiments of the present disclosure are described below with reference to FIG. 5A.

Referring to FIG. 5A, the server 164 may determine an item corresponding to an area within a distance designated vertical to a designated line in map data included in a database. According to one exemplary embodiment, the server 164 may determine as a 1^{st} highway area an area including a distance designated on a basis of the central line of a highway (e.g., a 1^{st} highway) in the map data included in the database of the electronic device 101 or the server 164 (for clear description below, the database is included in the server 164). If the server 164 receives location information and status information of the electronic device 101 from the electronic device 101, when the location information of the electronic device 101 is located within the 1^{st} highway area, the server 164 may determine if the electronic device 101 moves in the direction of an up line 530 or down line 520 on a basis of the central line 510 of the 1^{st} highway. For example, if the location information of the electronic device 101 is located within a designated distance 530 to the right on a basis of the central line 510 of the 1^{st} highway in the map data of the database, the server 164 may determine that the electronic device 101 is moving in the up line of the 1^{st} highway. If the electronic device 101 transmits data including the location information of the electronic device 101 and recommendation contents list request information to the server 164 while being moving in the up line of the 1^{st} highway, the server 164 may determine a recommendation contents list corresponding to the up line in the database, and may transmit the recommendation contents list to the electronic device 101.

Various embodiments of the present disclosure are described below with reference to FIG. 5B.

Referring to FIG. 5B, the moving electronic device 101 may receive a recommendation contents list of other electronic device 102 which moves in the same or similar forward direction with the electronic device 101. According to one exemplary embodiment, the electronic device 101 may acquire location information of the electronic device 101 while running in the direction of an up line 515 of a 1^{st} highway. The electronic device 101 may acquire information about at least one other electronic device (i.e., a fixed electronic device 511 or the mobile electronic device 102) around the electronic device 101 capable of providing recommendation contents lists through network communication. The electronic device 101 may receive identification data transmitted by the fixed electronic device 511 or the mobile electronic device 102 and acquire a status of each electronic device 511 or 102. According to one embodiment, the fixed electronic device 511 may include information about transmissible topic contents in the identification data and transmit the identification data including the information about the transmissible topic contents. The mobile electronic device 102 may include information about transmissible music contents in the identification data and transmit the identification data including the information about the transmissible music contents. In response to a recommendation music list request received from a user, the electronic device 101 may receive data transmitted by the mobile electronic device 102, or may transmit data requesting a recommendation music list, to the mobile electronic device 102. When the mobile electronic device 102 provides the recommendation music list to the electronic device 101, the mobile electronic device 102 may provide a result of filtering in accordance to a condition received from the user. It will be understood that the location information will be different while running in the direction of a down line 513 of a 1^{st} highway.

Various embodiments of the present disclosure are described below with reference to FIG. 5C.

Referring to FIG. 5C, with reference to data of the server 164, the moving electronic device 101 may receive recommendation contents lists of other electronic devices which move in the same or similar forwarding direction as the moving electronic device 101. In a description of FIG. 5C, the electronic device 101 may represent a 1^{st} electronic device 101, and other electronic devices may represent a 2^{nd} electronic device 104, a 3^{rd} electronic device 521, and a 4^{th} electronic device 527.

According to one embodiment, the electronic device 101 may acquire location information and movement status information of the electronic device 101 while being running in the direction of an up line 525 of a 1^{st} highway. The movement status information may include at least one of information such as information (e.g., identification information of a traveling highway) about a road where the electronic device 101 or a transport means (e.g., a car) in which the electronic device 101 is located is traveling, a movement direction of the electronic device 101, a designated destination (e.g., it may refer to information designated to a device such as a navigator) of the electronic device 101, a movement speed of the electronic device 101, a movement pattern of the electronic device 101, a movement period till a current time, an atmospheric temperature, and the current time. The electronic device 101 may, for example, periodically transmit the acquired location information and movement status information of the electronic device 101, to the server 164. The server 164 may update data received from the electronic device 101 to various items included in a database. The electronic device 101 may transmit data requesting a recommendation contents list to the server 164. With reference to the database, the server 164 may generate a recommendation contents list for consumed contents on the same or similar condition to that of the location information and movement status information of the electronic device 101. In response to a recommendation contents list request of the electronic device 101, the server 164 may directly transmit a recommendation contents list to the electronic device 101, or relay data transmission/reception with the 2^{nd} electronic device 104 having the same or similar condition as the electronic device 101.

The server 164 may acquire recommendation contents list request information received from the electronic device 101 and information about at least one other electronic device connected through network communication and consuming the same or similar contents. The server 164 may acquire information about other electronic devices (e.g., the 2^{nd} electronic device 104) located around the electronic device 101 in an area in which data transmission/reception is possible, with reference to the acquired location information about the at least one other electronic device. The server 164 may request the 2^{nd} electronic device 104 to transmit a list for consuming contents to the electronic device 101. The 2^{nd} electronic device 104 may generate and transmit the list of consuming contents to the electronic device 101. In a case where the 2^{nd} electronic device 104 may not determine a directly connectable network communication method (e.g., in a case where direct transmission is impossible), the 2^{nd} electronic device 104 may transmit the list of consuming contents to the electronic device 101 through the 3^{rd} electronic device 521 in which data relay (data transmission/reception) between the electronic device 101 and the 2^{nd} electronic device 104 is possible.

According to another embodiment, the 4^{th} electronic device 527 is traveling in the opposite direction of the electronic device 101, in the direction of a down line 523 of a 1^{st} highway, and may consume contents which do not coincide with a condition of recommendation contents list request data of the electronic device 101. However, in a case where the server 164 confirms a history in which the 4^{th} electronic device 527 sets and moves to the same or similar destination in the same direction as that of the electronic device 101 within a designated time (e.g., one or two days) with reference to the database of the server 164, the server 164 may acquire at least one content consumed at a corresponding time point. If a list of the at least one content acquired by the server 164 coincides with a designated condition of contents requested by the electronic device 101, the server 164 may transmit a recommendation contents list having been provided to the 4^{th} electronic device 527, to the electronic device 101. Or, the server 164 may request the 4^{th} electronic device 527 to transmit a corresponding contents list to the electronic device 101. In response to the request, the 4^{th} electronic device 527 may transmit the corresponding contents list to the electronic device 101.

Various embodiments of the present disclosure are described below with reference to FIG. 5D.

Referring to FIG. 5D, the server 164 may acquire movement status information of the electronic device 101 through a check point (e.g., an information collection device or a relay device) installed in a designated area, and may differentiate and provide a recommendation contents list in accordance to the acquired movement status information of the electronic device 101. In a description of FIG. 5D, the electronic device 101 may represent a 1^{st} electronic device 101, and other electronic device 104 may represent a 2^{nd} electronic device 104. At least one check point may represent a 1^{st} relay device 531, a 2^{nd} relay device 533, a 3^{rd} relay device 535, and a 4^{th} relay device 537.

According to one embodiment, each road may include a check point capable of acquiring information of the electronic device 101 that is traveling on a road. In a case of a highway, the 1^{st} relay device 531 and the 2^{nd} relay device 533 may acquire a time at which the electronic device 101 passes each of the relay devices 531 and 533, and may acquire a difference of the time at which the electronic device 101 passes each of the relay devices 531 and 533, and may acquire a direction in which the electronic device 101 moves. The 1^{st} relay device 531 or the 2^{nd} relay device 533 may transmit the acquired movement status information about the electronic device 101 to the server 164, and may determine a recommendation contents list corresponding to the movement status information of the electronic device 101, and may provide the determined recommendation contents list to the electronic device 101.

According to another embodiment, even when at least two roads are crossed like a crossroad, the server 164 may distinguish the electronic device 101 traveling on a road, through at least one check point installed in each road. In determining a movement path of the electronic device 101, if the electronic device 101 passes through a sensing range of the 2^{nd} relay device 533, the server 164 may receive movement status information of the electronic device 101 acquired by the 2^{nd} relay device 533. After the lapse of a predetermined time, if the electronic device 101 passes through a sensing range of the 1^{st} relay device 531, the server 164 may receive movement status information of the electronic device 101 acquired by the 2^{nd} relay device 533. With reference to the movement status information of the electronic device 101 acquired by the 1^{st} relay device 531 and the 2^{nd} relay device 533, the server 164 may determine that the electronic device 101 is traveling on a highway 550.

According to another embodiment, in determining a movement path of the 2^{nd} electronic device 104, if the 2^{nd} electronic device 104 passes through a sensing range of the 3^{rd} relay device 535, the server 164 may receive movement status information of the 2^{nd} electronic device 104 acquired by the 3^{rd} relay device 535. After the lapse of a predetermined time, if the 2^{nd} electronic device 104 passes through a sensing range of the 4^{th} relay device 537, the server 164 may receive movement status information of the 2^{nd} electronic device 104 acquired by the 4^{th} relay device 537. With reference to the movement status information of the 2^{nd} electronic device 104 acquired by the 3^{rd} relay device 535 and the 4^{th} relay device 537, the server 164 may determine that the 2^{nd} electronic device 104 is traveling on an ordinary road 560.

In providing a recommendation contents list to the electronic device 101 or the 2^{nd} electronic device 104, with reference to the movement status information of the electronic device 101 or the 2^{nd} electronic device 104, the server 164 may determine the recommendation contents list coinciding with a corresponding condition. According to one exemplary embodiment, in providing the recommendation contents list to the electronic device 101, the server 164 may determine the recommendation contents list based on contents consumed on the highway 550 on which the electronic device 101 is traveling. In providing the recommendation contents list to the 2^{nd} electronic device 104, the server 164 may determine the recommendation contents list based on contents consumed on the ordinary road 560 on which the electronic device 104 is traveling.

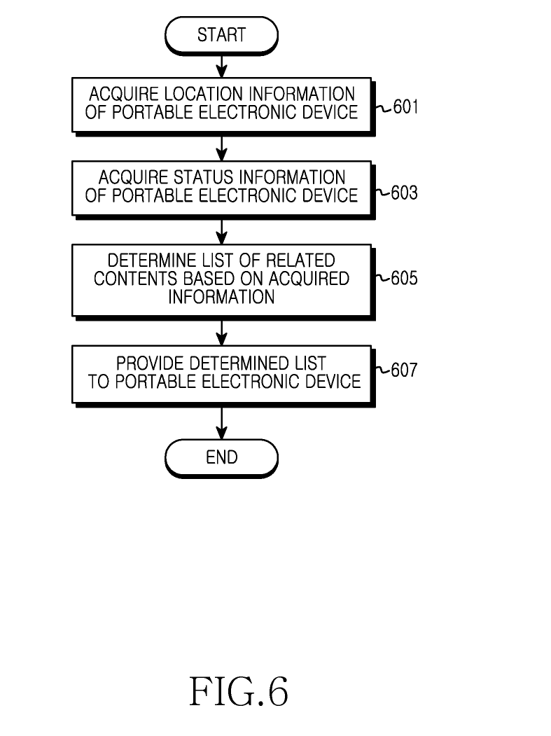

FIG. 6 is a flowchart illustrating an operation of transmitting/receiving data in the electronic device 101 or the server 164 according to various embodiments of the present disclosure.

The electronic device 101 may acquire location information or movement status information of the electronic device 101, and transmit the acquired location information or movement status information to the server 164, together with information about contents consumed by the electronic device 101. The electronic device 101 may transmit to the server 164 a recommendation contents list request for contents desired to be consumed by the electronic device 101. In a database accumulated based on log information received from the electronic device 101 or at least one other electronic device, the server 164 may determine a recommendation contents list (e.g., an arrangement according to the designated order of priority) of contents consumed in the same or similar state to that of the location information or movement status information of the electronic device 101. And, the server 164 may transmit the determined recommendation contents list to the electronic device 101. The electronic device 101 may perform all or some functions of the server 164. Accordingly, in a description of an exemplary embodiment of FIG. 6 below, the server 164 may be described as the electronic device 101.

Referring to FIG. 6, in operation 601, the electronic device 101 may receive location information representing an area in which a portable electronic device is located and movement status information representing at least one of the movement direction of the portable electronic device, a speed of the portable electronic device, a road on which the portable electronic device is traveling, and a destination of the portable electronic device, from at least one other electronic device (e.g., the portable electronic device) connected through network communication. The location information or movement status information of the portable electronic device may be acquired by the electronic device 101 through periodical transmission of the portable electronic device, or may be acquired in response to a request of the electronic device 101.

In operation 603, the electronic device 101 may receive status information of the portable electronic device such as an external temperature of the portable electronic device, an altitude, a noise, weather, or a current time, from the one or other electronic devices (e.g., the portable electronic device) connected through network communication. The status information of the portable electronic device may be acquired by the electronic device 101 through periodical transmission of the portable electronic device, or may be acquired in response to a request of the electronic device 101.

In operation 605, the electronic device 101 may distinguish information about at least one content included in the database by various conditions (e.g., a location of the portable electronic device, a movement direction thereof, a destination thereof, a movement speed thereof, an external temperature thereof, an altitude thereof, a noise, weather, and a time) with reference to the location information, movement status information, and status information acquired from the at least one portable electronic device, and generate a list of consumed contents.

In operation 607, the electronic device 101 may transmit the generated contents list to the portable electronic device satisfying a corresponding condition. In response to a request of the portable electronic device, the electronic device 101 may determine and transmit a contents list of a corresponding condition. The electronic device 101 may receive feedback information about consumed contents in the provided contents list, and may reflect the received feedback information and update the database.

If operation 607 is ended, the electronic device 101 may terminate the embodiment of FIG. 6.

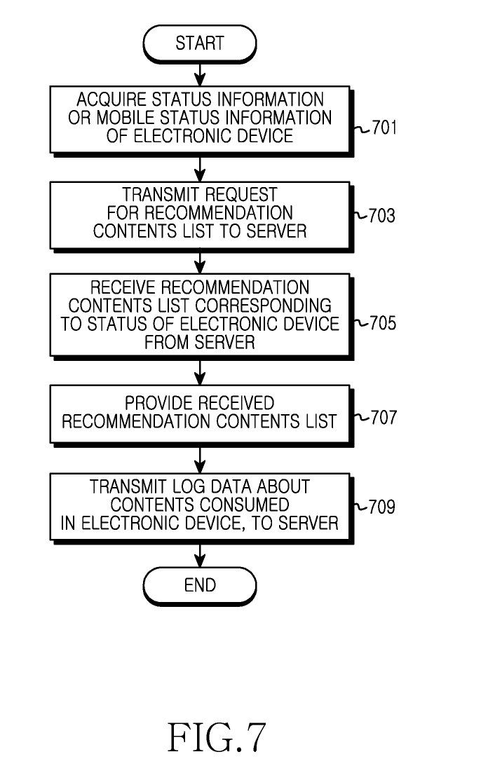

FIG. 7 is a flowchart illustrating an operation of transmitting/receiving data in the electronic device 101 or the server 164 according to various embodiments of the present disclosure.

The electronic device 101 may receive a recommendation contents list which is determined with reference to at least one of location information of the electronic device 101, movement status information of the electronic device 101, and external status information of the electronic device 101, from the server 164. The electronic device 101 may transmit a recommendation contents list request for the kind of contents desired by a user, to the server 164. The electronic device 101 may receive the requested recommendation contents list from the server 164 and provide the recommendation contents list to the user.

Referring to FIG. 7, in operation 701, the electronic device 101 may receive location information representing an area where the electronic device 101 is located and movement status information representing at least one of a movement direction of the electronic device 101, a speed thereof, a road on which the electronic device 101 is traveling, and a destination thereof, from a portable electronic device. Also, the electronic device 101 may acquire status information such as an external temperature of the electronic device 101, an altitude thereof, weather, or a current time, through one or one sensors included in the electronic device 101.

In operation 703, the electronic device 101 may transmit information requesting a recommendation contents list of the kind of contents desired by the user, to the server 164, together with all or part of the location information of the electronic device 101 acquired through the at least one sensor included in the electronic device 101, the movement status information thereof, and external status information of the electronic device 101. The electronic device 101 may periodically transmit the recommendation contents list request information to the server 164.

In operation 705, the electronic device 101 may receive from the server 164 a recommendation contents list determined coinciding with one or designated condition with reference to all or part of the location information of the electronic device 101 acquired from the electronic device 101, the movement status information thereof, and the external status information of the electronic device 101. The electronic device 101 may receive the recommendation contents list in response to a request of the electronic device 101, and may receive the recommendation contents list through periodical transmission of the server 164. In accordance to the control of the server 164, the electronic device 101 may receive the recommendation contents list requested to the server 164, from at least one other electronic device connected through network communication.

In operation 707, the electronic device 101 may provide the user with the recommendation contents list received from the server 164, and may provide to consume contents in accordance to the recommendation contents list. In providing the received recommendation contents list in the electronic device 101, the electronic device 101 may provide a result of filtering the received recommendation contents list in accordance to at least one condition designated to the electronic device 101. According to one embodiment, in providing the acquired recommendation contents (e.g., music) list, the electronic device 101 may filter the acquired recommendation contents list on at least one condition such as a preferred musician, a reproduction time, and ranking and may provide the filtering result to the electronic device 101.

In operation 709, the electronic device 101 may transmit log information about contents consumed with reference to the received recommendation contents list, to the server 164. The server 164 may update the received log information to a database of the server 164. The server 164 may reflect the updated log information when determining a recommendation contents list later. The electronic device 101 may transmit not only information about the contents consumed based on the recommendation contents list but also information about various contents consumed by the electronic device 101 to the server 164, together with the location information of the electronic device 101, the movement status information of the electronic device 101, or the external status information of the electronic device 101.

When operation 709 is ended, the electronic device 101 may terminate an embodiment of FIG. 7.

According to various embodiments of the present disclosure an operation method of a 1^{st} electronic device may include the operations of transmitting status information of the 1^{st} electronic device and a request for a list of at least one related content corresponding to the status information, to a 2^{nd} electronic device, the status information including location of the 1^{st} electronic device, receiving from the 2^{nd} electronic device a list of at least one related content, the list of at least one related content being determined in accordance to an area attribute corresponding to a location of the 1^{st} electronic device based on the location information of the 1^{st} electronic device, and outputting the at least one related content included in the list.

According to various embodiments, before the operation of outputting, the method may further include the operation of filtering the received list of at least one related content on at least one condition associated with the 1^{st} electronic device.

According to various embodiments, the method may further include the operations of selecting one content among the at least one related content, and feeding back information of the selected one content to the 2^{nd} electronic device.

According to various embodiments, the status information may further include time information of the 1^{st} electronic device, temperature information of the 1^{st} electronic device, humidity information of the 1^{st} electronic device, and pressure information of the 1^{st} electronic device.

According to various embodiments, the 1^{st} electronic device is a mobile terminal, and the 2^{nd} electronic device is a server.

According to various embodiments, the location information is acquired through at least one of base station triangulation, GPS measurement, gyroscope sensor measurement, geomagnetic sensor measurement, accelerometer sensor measurement, WiFi sensor measurement, WiFi triangulation, and Zigbee sensor measurement in the 2^{nd} electronic device.

According to various embodiments of the present disclosure, an operation method of a 1^{st} electronic device may include the operations of receiving status information of a 2^{nd} electronic device from the 2^{nd} electronic device, the status information including location information of the 2^{nd} electronic device, determining a list of at least one related content based on the location information of the 2^{nd} electronic device, the list of at least one related content being determined in accordance to an area attribute corresponding to a location of the 2^{nd} electronic device, and providing the determined list to the 2^{nd} electronic device.

According to various embodiments, the area attribute may be determined based on an area attribute table stored in the 1^{st} electronic device and including a plurality of area attributes corresponding to a plurality of locations. According to one exemplary embodiment, the area attribute table may include the list of at least one related content corresponding to the area attributes. According to one exemplary embodiment, the area attribute table may include information about contents consumed in an environment corresponding to at least one of time information, temperature information, humidity information, and pressure information.

According to various embodiments, with reference to the status information of the 2^{nd} electronic device, the list of at least one related content is determined as at least one of list of contents consumed in an environment satisfying at least one condition of an external temperature of the 2^{nd} electronic device, an air pressure thereof, a noise, a humidity, and a time.

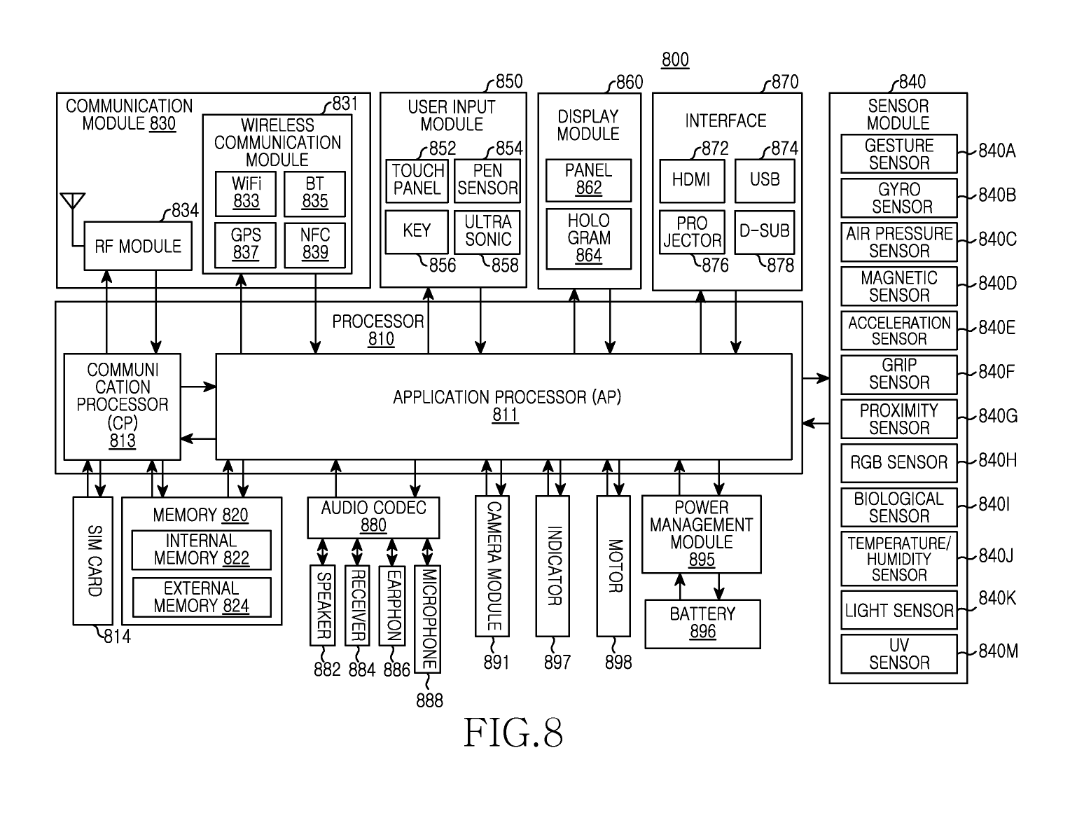

FIG. 8 is a block diagram illustrating a construction of hardware according to various embodiments of the present disclosure.

The hardware may construct all or part of the electronic device 101 illustrated in FIG. 1, for example.

Referring to FIG. 8, the hardware 800 includes at least one processor 810, a Subscriber Identification Module (SIM) card 814, a memory 820, a communication module 830, a sensor module 840, a user input module 850, a display module 860, an interface 870, an audio codec 880, a camera module 891, a power management module 895, a battery 896, an indicator 897, and a motor 898, but is not limited thereto.

The processor 810 (e.g., the processor 120 of FIG. 1) may include at least one Application Processors (APs) 811 or at least one Communication Processor (CP) 813. The processor 810 may be, for example, the processor 120 illustrated in FIG. 1. Although it is illustrated that the AP 811 and the CP 813 are included within the processor 810 in FIG. 8, the AP 811 and the CP 813 may be each included within different IC packages, respectively. In one exemplary embodiment, the AP 811 and the CP 813 may be included within one IC package.

The AP 811 may drive an operating system or an application program to control a plurality of hardware or software constituent elements connected to the AP 811, and perform processing and operations of various data including multimedia data. The AP 811 may be, for example, implemented as a System on Chip (SoC). According to one exemplary embodiment, the processor 810 may further include a Graphic Processing Unit (GPU) (not shown).

The CP 813 may perform a function of managing a data link and converting a communication protocol in communication between the electronic device (e.g., the electronic device 101) including the hardware 800 and other electronic devices connected through a network 162. The CP 813 may be implemented as a SoC, for example. According to one exemplary embodiment, the CP 813 may perform at least part of a multimedia control function. The CP 813 may perform terminal distinction and authentication within a communication network using a subscriber identity module (e.g., the SIM card 814). Also, the CP 813 may provide services such as voice telephony, video telephony, a text message, packet data or the like, to a user.

Also, the CP 813 may control data transmission/reception of the communication module 830. Although the constituent elements such as the CP 813, the power management module 895, the memory 820 and the like are illustrated as constituent elements separate from the AP 811 in FIG. 8, according to one exemplary embodiment, the AP 811 may be implemented to include at least some (e.g., the CP 813) of the aforementioned constituent elements.

According to one embodiment, the AP 811 or the CP 813 may load into a volatile memory an instruction and/or data received from a nonvolatile memory connected to each of the AP 811 and the CP 813 or from at least one of other constituent elements, and process the loaded instruction or data. Also, the AP 811 or the CP 813 may store in the nonvolatile memory data which are received from at least one of the other constituent elements or are generated by at least one of the other constituent elements.

The SIM card 814 may be a card implementing the subscriber identity module, and may be inserted into a slot provided in a specific location of the electronic device. The SIM card 814 may include unique identification information (e.g., Integrated Circuit Card ID (ICCID)) or subscriber information (e.g., International Mobile Subscriber Identity (IMSI)).

The memory 820 may include an internal memory 822 or an external memory 824. The memory 820 may be the memory 130 illustrated in FIG. 1, for example. The internal memory 822 may include, for example, at least one of a volatile memory (e.g., a Dynamic Random Access Memory (DRAM), a Static Random Access Memory (SRAM), a Synchronous Dynamic Random Access Memory (SDRAM) and the like) or a nonvolatile memory (e.g., a One Time Programmable Read Only Memory (OTPROM), a Programmable ROM (PROM), an Erasable Programmable ROM (EPROM), an Electrically Erasable Programmable ROM (EEPROM), a mask Read Only Memory (ROM), a flash ROM, a Not AND (NAND) flash memory, a Not OR (NOR) flash memory and the like). According to one exemplary embodiment, the internal memory 822 may take a form of Solid State Drive (SSD). The external memory 824 may further include, for example, Compact Flash (CF), Secure Digital (SD), Micro Secure Digital (Micro-SD), Mini Secure Digital (Mini-SD), extreme Digital (xD), a memory stick and the like.

The communication module 830 may include a wireless communication module 831 or a Radio Frequency (RF) module 834. The communication module 830 may be, for example, the communication interface 160 illustrated in FIG. 1. The wireless communication module 831 may include, for example, WiFi 833, BT 835, GPS 837 or NFC 839. For example, the wireless communication module 831 may provide a wireless communication function using radio frequency. Additionally or alternatively, the wireless communication module 831 may include a network interface (e.g., a LAN card), a modem or the like for connecting the hardware 800 with a network (e.g., the Internet, a LAN, a WAN, a telecommunication network, a cellular network, a satellite network, a POTS or the like).

The RF module 834 may take charge of transmission/reception of data, for example, transmission/reception of an RF signal or a called electric signal. Though not illustrated, the RF module 834 may include, for example, a transceiver, a Power Amp Module (PAM), a frequency filter, a Low Noise Amplifier (LNA) or the like. Also, the RF module 834 may further include a component for transmitting/receiving an electromagnetic wave on a free space in wireless communication, for example, a conductor, a conductive line or the like.

The sensor module 840 may include at least one of, for example, a gesture sensor 840A, a gyro sensor 840B, an air pressure sensor 840C, a magnetic sensor 840D, an acceleration sensor 840E, a grip sensor 840F, a proximity sensor 840G, a Red Green Blue (RGB) sensor 840H, a biological sensor 840I, a temperature/humidity sensor 840J, a light sensor 840K, and a Ultraviolet (UV) sensor 840M and the like. The sensor module 840 may meter a physical quantity or sense an activation state of the electronic device and convert the measured or sensed information into an electrical signal. Additionally or alternatively, the sensor module 840 may include, for example, an Electronic nose (E-nose) sensor (not shown), an Electromyography (EMG) sensor (not shown), an Electroencephalogram (EEG) sensor (not shown), an Electrocardiogram (ECG) sensor (not shown), a fingerprint sensor (not shown) and the like. The sensor module 840 may further include a control circuit for controlling at least at least one sensor provided therein.

The user input module 850 may include a touch panel 852, a (digital) pen sensor 854, a key 856, or an ultrasonic input device 858. The user input module 850 may be, for example, the input/output interface 140 illustrated in FIG. 1. The touch panel 852 may recognize, for example, a touch input in at least one method among a capacitive method, a pressure sensitive method, an infrared method, and an ultrasonic method. Also, the touch panel 852 may further include a controller (not shown). In the capacitive method, not only direct touch but also proximity recognition is possible. The touch panel 852 may further include a tactile layer. In this case, the touch panel 852 may provide a tactile response to a user.

The (digital) pen sensor 854 may be implemented, for example, using the same or similar method to receiving a user's touch input or a separate recognition sheet. The key 856 may be, for example, a keypad or a touch key. The ultrasonic input device 858 is a device capable of sensing a sound wave by a microphone (e.g., a microphone 888) of the electronic device and confirming data through a pen generating an ultrasonic signal. The ultrasonic input device 858 may perform wireless recognition. According to one exemplary embodiment, the hardware 800 may receive a user input from an external device (e.g., a network, a computer, or a server) connected to the hardware 800 using the communication module 830.

The display module 860 may include a panel 862 or a hologram 864. The display module 860 may be, for example, the display module 150 illustrated in FIG. 1. The panel 862 may be, for example, a Liquid Crystal Display (LCD), an Active-Matrix Organic Light-Emitting Diode (AMOLED), or the like. The panel 862 may be implemented to be flexible, transparent, or wearable, for example. The panel 862 may be constructed as one module together with the touch panel 852. The hologram 864 may show a three-dimensional image in the air by using interference of light. According to one exemplary embodiment, the display module 860 may further include a control circuit for controlling the panel 862 or the hologram 864.

The interface 870 may include, for example, a High-Definition Multimedia Interface (HDMI) 872, a Universal Serial Bus (USB) 874, a projector 876, or a D-subminiature (D-sub) 878. Additionally or alternatively, the interface 870 may include, for example, Secure Digital/Multi Media Card (SD/MMC) (not shown) or Infrared Data Association (IrDA) (not shown).

The audio codec 880 may convert a voice and an electric signal interactively. The audio codec 880 may convert, for example, voice information that is inputted or outputted through a speaker 882, a receiver 884, an earphone 886, a microphone 888, and the like.

The camera module 891 is a device capable of taking a picture and a video. According to one embodiment, the camera module 891 may include at least one image sensor (e.g., front lenses or rear lenses), an Image Signal Processor (ISP) (not shown), or a flash LED (not shown).

The power management module 895 may manage power of the hardware 800. Though not illustrated, the power management module 895 may include, for example, a Power Management Integrated Circuit (PMIC), a charging Integrated Circuit (IC), and a battery gauge.

The PMIC may be mounted, for example, within an integrated circuit or a SoC semiconductor. A charging method may be divided into wired and wireless. The charging IC may charge a battery, and may prevent the inflow of overvoltage or overcurrent from an electric charger. According to one exemplary embodiment, the charging IC may include a charging IC for at least one of a wired charging method and a wireless charging method. The wireless charging method may be, for example, a magnetic resonance method, a magnetic induction method, an electromagnetic method and the like. The charging IC may additionally include a supplementary circuit for wireless charging, for example, a coil loop, a resonance circuit, a rectifier circuit or the like.

The battery gauge may measure, for example, a level of the battery 896, a charging voltage thereof, an electric current thereof, or a temperature thereof. The battery 896 may generate electricity and supply a power source. The battery 896 may be, for example, a chargeable cell.

The indicator 897 may display a specific state of the hardware 800 or a part (e.g., the AP 811) thereof, for example, a booting state, a message state, a charging state or the like. The motor 898 may convert an electrical signal into a mechanical vibration. A Micro Controller Unit (MCU) may control the sensor module 840.

Though not illustrated, the hardware 800 may include a processing device (e.g., a GPU) for mobile TV support. The processing device for mobile TV support may process, for example, standard media data of Digital Multimedia Broadcasting (DMB), Digital Video Broadcasting (DVB), a media flow or the like. The aforementioned constituent elements of the hardware according to various embodiments of the present disclosure may be each composed of at least one part, and the names of the aforementioned constituent elements may be varied according to the kind of the hardware. The hardware according to various embodiments of the present disclosure may include at least one of the aforementioned constituent elements, and may omit some constituent elements or further include additional other constituent elements. Also, some of the constituent elements of the hardware according to various embodiments of the present disclosure are coupled and constructed as one entity, thereby being able to identically perform functions of the corresponding constituent elements of before being coupled.

According to various embodiments of the present disclosure, a 1^{st} electronic device may include a memory including at least one content information about an area attribute of the 1^{st} electronic device, a processor 120 transmitting status information of the 1^{st} electronic device and a request for a list of at least one related content corresponding to the status information to a 2^{nd} electronic device, the status information including location information of the 1^{st} electronic device, and receiving from the 2^{nd} electronic device a list of at least one related content, the list of at least one related content being determined in accordance to an area attribute corresponding to a location of the 1^{st} electronic device based on the location information of the 1^{st} electronic device, and outputting the at least one related content included in the list.

According to various embodiments, before outputting, the processor 120 may filter the list of at least one related content received on at least one condition associated with the 1^{st} electronic device.

According to various embodiments, the processor 120 may select one content among the at least one content, and feeds back information of the selected one content to the 2^{nd} electronic device.

According to various embodiments, the processor 120 may include time information of the 1^{st} electronic device, temperature information of the 1^{st} electronic device, humidity information of the 1^{st} electronic device, and pressure information of the 1^{st} electronic device, in the status information.

According to various embodiments, the processor 120 may acquire the location information through at least one of base station triangulation, GPS measurement, gyroscope sensor measurement, geomagnetic sensor measurement, accelerometer sensor measurement, WiFi sensor measurement, WiFi triangulation, and Zigbee sensor measurement in the 2^{nd} electronic device.

According to various embodiments of the present disclosure, a 1^{st} electronic device may include a memory including at least one content information about an area attribute of the 1^{st} electronic device, a processor 120 receiving status information including location information of a 2^{nd} electronic device, from the 2^{nd} electronic device, and determining a list of at least one related content in accordance to an area attribute corresponding to a location of the 2^{nd} electronic device based on the location information of the 2^{nd} electronic device, and providing the determined list to the 2^{nd} electronic device.

According to various embodiments, the processor 120 may determine the area attribute based on an area attribute table stored in the 1^{st} electronic device and including a plurality of area attributes corresponding to a plurality of locations. According to one exemplary embodiment, the processor may include in the area attribute table the list of at least one related content corresponding to the area attributes. According to one exemplary embodiment, the processor 120 may include in the area attribute table information about contents consumed in an environment corresponding to at least one of time information, temperature information, humidity information, and pressure information.

According to various embodiments, with reference to the status information of the 2^{nd} electronic device, the processor 120 may determine the list of at least one related content as at least one of list of contents consumed in an environment satisfying at least one condition of an external temperature of the 2^{nd} electronic device, an air pressure thereof, a noise, a humidity, and a time.

In a method for recommending the optimal contents to a user based on context information of a user who is located in a designated space area, the electronic device may provide user-fitted contents by gathering and analyzing information about consumed contents through various information such as a space information database, sensor information of the electronic device, a user profile, a use pattern of the electronic device, information inputted to the electronic device, external data of the electronic device.

A term “module” used in various embodiments of the present disclosure may represent, for example, a unit including a combination of at least one of hardware, software, and firmware. The “module” may be used interchangeably with terms of, for example, a unit, a logic, a logical block, a component, a circuit or the like. The “module” may be the minimum unit of an integrally constructed component or a part thereof. The “module” may be also the minimum unit performing at least one function or a part thereof. The “module” may be implemented mechanically or electronically. For example, the “module” according to various exemplary embodiments of the present disclosure may include at least one of an Application-Specific Integrated Circuit (ASIC) chip, Field-Programmable Gate Arrays (FPGAs) and an application-possible logic device performing some operations known to the public or to be developed in the future.

According to various embodiments, at least part of an apparatus (e.g., modules or functions thereof) or method (e.g., operations) according to the present disclosure may be implemented by, for example, instructions stored in a computer-readable storage media in a form of a programming module. When the instruction is executed by at least one processor, the at least one processor may perform functions corresponding to the instructions. The computer-readable storage media may be the memory 820, for instance. At least part of the programming module may be implemented (e.g., executed), for example, by the processor 811. At least part of the programming module may include, for example, a module, an application, a routine, a set of instructions, a process or the like for performing at least one function.

The programming module according to various embodiments of the present disclosure may include at least at least one of the aforementioned constituent elements, or omit some of the aforementioned constituent elements, or include additional other constituent elements. Operations carried out by the module, the programming module or the other constituent elements according to the present disclosure may be executed in a sequential, parallel, repeated or heuristic method. Also, some operations may be executed in different order or may be omitted, or other operations may be added.

The computer-readable recording media may include a magnetic media such as a hard disk, a floppy disk, and a magnetic tape, an optical media such as a Compact Disc-Read Only Memory (CD-ROM) and a Digital Versatile Disc (DVD), a Magneto-Optical Media such as a floptical disk, and a hardware device specially configured to store and perform an application instruction (e.g., the programming module) such as a Read Only Memory (ROM), a Random Access Memory (RAM), a flash memory and the like. Also, the application instruction may include not only a mechanical code such as a code made by a compiler but also a high-level language code executable by a computer using an interpreter and the like. The aforementioned hardware device may be constructed to operate as at least one software module in order to perform an operation of the present disclosure, and vice versa.

And, embodiments of the present disclosure disclosed in the present specification and drawings merely suggest specific examples so as to easily describe the technological content of the present disclosure and help the understanding of the present disclosure, and do not intend to limit the spirit and scope of the present disclosure. Accordingly, it should be understood that the scope of the present disclosure includes all modifications or deformed forms drawn on the basis of the technological spirit of the present disclosure besides the exemplary embodiments disclosed herein.

While the present disclosure has been shown and described with reference to various embodiments thereof, it will be understood by those skilled in the art that various changes in form and details may be made therein without departing from the spirit and scope of the invention as defined by the appended claims and their equivalents.

What is claimed is:

1. A method of processing data in an electronic device, the method comprising:
detecting status information and location information of the electronic device requesting for a list of at least one related content based on the detected status information and the detected location information, to another electronic device;
receiving the list of at least one related content from the other electronic device; and
displaying the received list of at least one related content.

2. The method of claim 1, further comprising:
filtering the received list of at least one related content based on at least one condition.

3. The method of claim 1, further comprising:
selecting at least one content among the at least one related content; and
feeding back information of the selected one content to the other electronic device.

4. The method of claim 1, wherein the status information further comprises time information of the electronic device, temperature information of the electronic device, humidity information of the electronic device, and pressure information of the electronic device.

5. The method of claim 1, wherein the electronic device is a mobile terminal, and the other electronic device is a server.

6. The method of claim 1, wherein the location information is acquired through at least one of base station triangulation, Global Positioning System (GPS) measurement, gyroscope sensor measurement, geomagnetic sensor measurement, accelerometer sensor measurement, Wireless Fidelity (WiFi) sensor measurement, WiFi triangulation, and Zigbee sensor measurement in the other electronic device.

7. An operation method of an electronic device, the method comprising:
receiving status information and location information of another electronic device, from the other electronic device;
determining a list of at least one related content based on the received status information and the received location information; and
providing the determined list of at least one related content to the other electronic device.

8. The method of claim 7, wherein the location information is determined based on an area attribute table stored in the electronic device and comprising a plurality of area attributes corresponding to a plurality of locations.

9. The method of claim 8, wherein the area attribute table comprises the list of at least one related content corresponding to the area attributes.

10. The method of claim 9, wherein the area attribute table comprises information about contents consumed in an environment corresponding to at least one of time information, temperature information, humidity information, and pressure information.

11. The method of claim 7, wherein, with reference to the status information of the other electronic device, the list of at least one related content is determined as at least one of lists of contents consumed in an environment satisfying at least one condition of an external temperature of the other electronic device, an air pressure thereof, a noise, a humidity, and a time.

12. The method of claim 7, further comprising determining a 2^{nd} list of corresponding related contents based on at least one location and information other than the location information among the status information.

13. The method of claim 7, further comprising determining a 2^{nd} list of at least one related content which is determined based on at least one other location related to the area attributes.

14. An electronic device comprising:
a display;
a communication interface configured to communicate with another electronic device; and
at least one processor operatively coupled to the display and the communication interface, the at least one processor configured to perform:
detecting status information and location information of the electronic device;
requesting for a list of at least one related content based on the detected status information and the detected the location information to other electronic device,
receiving the list of at least one related content from the other electronic device; and
displaying the received list of at least one related content.

15. The electronic device of claim 14, wherein, before outputting, the processor filters the list of at least one related content received on at least one condition associated with the electronic device.

16. The electronic device of claim 14, wherein the processor selects one content among the at least one content, and feeds back information of the selected one content to the other electronic device.

17. The electronic device of claim 14, wherein the processor comprises time information of the electronic device, temperature information of the electronic device, humidity information of the electronic device, and pressure information of the electronic device, in the status information.

18. The electronic device of claim 14, wherein the processor acquires the location information through at least one of base station triangulation, Global Positioning System (GPS) measurement, gyroscope sensor measurement, geomagnetic sensor measurement, accelerometer sensor measurement, Wireless Fidelity (WiFi) sensor measurement, WiFi triangulation, and Zigbee sensor measurement in the other electronic device.

19. An electronic device comprising:
a communication interface configured to communicate one of information and a list of contents with another electronic device; and
at least one processor programed to receive status information and location information of other electronic device from the other electronic device, to detect a list of at least one related content based on the received status information and the received location information, and to provide the detected list of at least one related content to the other electronic device.

20. The electronic device of claim 19, wherein the processor determines the area attribute based on an area attribute table stored in the electronic device and comprising a plurality of area attributes corresponding to a plurality of locations.

21. The electronic device of claim 20, wherein the processor comprises in the area attribute table the list of at least one related content corresponding to the area attributes.

22. The electronic device of claim 21, wherein the processor comprises in the area attribute table information about contents consumed in an environment corresponding to at least one of time information, temperature information, humidity information, and pressure information.

23. The electronic device of claim 19, wherein, with reference to the status information of the other electronic device, the processor determines the list of at least one related content as at least one of lists of contents consumed in an environment satisfying at least one condition of an external temperature of the other electronic device, an air pressure thereof, a noise, a humidity, and a time.

24. The electronic device of claim 19, wherein the processor determines a 2^{nd} list of corresponding related contents based on at least one location and information other than the location information among the status information.

25. The electronic device of claim 19, wherein the processor determines a 2^{nd} list of at least one related content, which is determined based on at least one other location related to the area attributes.

26. The electronic device of claim 25, wherein the determined 2^{nd} list of at least one related content is determined based upon a direction on a particular road the electronic device is travelling.

27. The electronic device of claim 25, wherein the determined 2^{nd} list of at least one related content is further determined based upon other devices travelling on the particular road in proximity to the electronic device.
